(19) United States
(12) Patent Application Publication
(10) Pub. No.: US 2017/0005934 A1
(43) Pub. Date: Jan. 5, 2017

(54) APPARATUS AND METHOD FOR TRANSFERRING DATA ONTO ANOTHER NETWORK DEPENDING ON AN AMOUNT OF DATA FLOW IN A NETWORK

(71) Applicant: FUJITSU LIMITED, Kawasaki-shi (JP)

(72) Inventors: Shingo HIRONAKA, Kawasaki (JP); Takashi HONDA, Kawasaki (JP)

(73) Assignee: FUJITSU LIMITED, Kawasaki-shi (JP)

(21) Appl. No.: 15/187,190

(22) Filed: Jun. 20, 2016

(30) Foreign Application Priority Data
Jul. 3, 2015 (JP) 2015-134682

(51) Int. Cl. H04L 12/801; H04B 10/27

(52) U.S. Cl. CPC H04L 47/12; H04B 10/27

(57) ABSTRACT

A transmission device includes a plurality of first cards each being coupled to a first line through which a first signal is transmitted, and a second card coupled to a second line through which a second signal enabling insertion of the first signal is transmitted. The transmission device determines whether or not a data amount of the first signal exceeds a predetermined threshold in the first card, and when the data amount of the first signal exceeds the predetermined threshold, the transmission device causes the second card to set, based on destination information in the first signal, the second line through which the first signal is to be transferred.

### CROSS-REFERENCE TO RELATED APPLICATION

This application is based upon and claims the benefit of priority of the prior Japanese Patent Application No. 2015-134682, filed on Jul. 3, 2015, the entire contents of which are incorporated herein by reference.

### FIELD

The embodiment discussed herein is related to apparatus and method for transferring data onto another network depending on an amount of data flow in a network.

### BACKGROUND

Optical transport network (OTN) transmission methods defined by the Institute of Electrical and Electronic Engineers (IEEE) and the International Telecommunication Union-Telecommunication (ITU-T) G.709 standard are standardized. OTN is a method in which a client signal that flows in an optical network (NW) is stored in an optical channel transport unit (OTU) and is transmitted. OTN is a technology in which client signals of different types may be transparently transmitted in an optical NW to which a wavelength division multiplexing (WDM) technology is applied.

In recent years, in order to reduce capital expenditure (CAPEX) and operating expenditure (OPEX), multi-layer transmission devices that support WDM (Layer 0), OTN (Layer 1), and packets (Layer 2) have been developed. Such a transmission device may transfer a reception packet to a destination via an OTN path whose transmission unit price per bit is low.

In a packet NW, each transmission device generates a MAC table that manages a transmission destination for each destination MAC address, refers to the MAC table, and transfers a packet to a transmission destination in accordance with the destination MAC address. In an OTNNW, each transmission device in a NW is centrally controlled by a management device, an OTN path is set by an administrator, and an OTN frame is transmitted via the OTN path that has been set.

Japanese Laid-open Patent Publication No. 2013-106153 discusses related art.

### SUMMARY

According to an aspect of the invention, an apparatus includes a plurality of first cards each being coupled to a first line through which a first signal is transmitted, and a second card coupled to a second line through which a second signal enabling insertion of the first signal is transmitted. The apparatus determines whether or not a data amount of the first signal exceeds a predetermined threshold in the first card. When the data amount of the first signal exceeds the predetermined threshold, the apparatus causes the second card to set, based on destination information in the first signal, the second line through which the first signal is to be transferred.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a transmission system, according to an embodiment;

FIG. 2 is a diagram illustrating an example of a hardware configuration of a transmission device, according to an embodiment;

FIG. 3 is a diagram illustrating an example of a functional configuration of a transmission device, according to an embodiment;

FIG. 4 is a table illustrating an example of a MAC table;

FIG. 5 is a diagram illustrating an example of a conversion table, according to an embodiment;

FIG. 6 is a diagram illustrating an example of a format configuration of an OTN frame, according to an embodiment;

FIG. 7 is a diagram illustrating an example of an operation performed when a reception packet of a packet NW is transferred through an OTN path, according to an embodiment;

FIG. 8 is a diagram illustrating an example of an operational sequence for path checking processing of a transmission device, according to an embodiment;

FIG. 9 is a diagram illustrating an example of an operational sequence for path setting processing of a transmission device, according to an embodiment;

FIG. 10 is a diagram illustrating an example of an operational sequence for path removal processing of a transmission device, according to an embodiment;

FIG. 11 is a diagram illustrating an example of an operational flowchart for start point side setting processing of a transmission device, according to an embodiment;

FIG. 12 is a diagram illustrating an example of an operational flowchart for start point side transfer processing of a transmission device, according to an embodiment;

FIG. 13 is a diagram illustrating an example of an operational flowchart for relay point side setting processing of a transmission device, according to an embodiment; and

FIG. 14 is a diagram illustrating an example of an operational flowchart for end point side setting processing of a transmission device, according to an embodiment.

### DESCRIPTION OF EMBODIMENT

In each transmission device in a transmission system, in which a packet NW and an OTNNW are constructed with the same topology, a reception packet may be transmitted via an OTN path, not via a packet path. However, it is difficult to automatically set an OTN path. Moreover, as the number of transmission devices in the transmission system increases, the processing load thereof increases.

It is desirable to provide a transmission device, a transmission method, and a transmission system that enable automatic setting of an OTN path through which a packet is transferred.

An embodiment related to a transmission device, a transmission method, and a transmission system according to the present disclosure will be described below in detail with reference to the accompanying drawings. Note that the present disclosure technology is not limited to the embodiment described below. Also, the embodiment described below may be combined with another embodiment, as appropriate, in a range where the embodiments do not contradict each other.

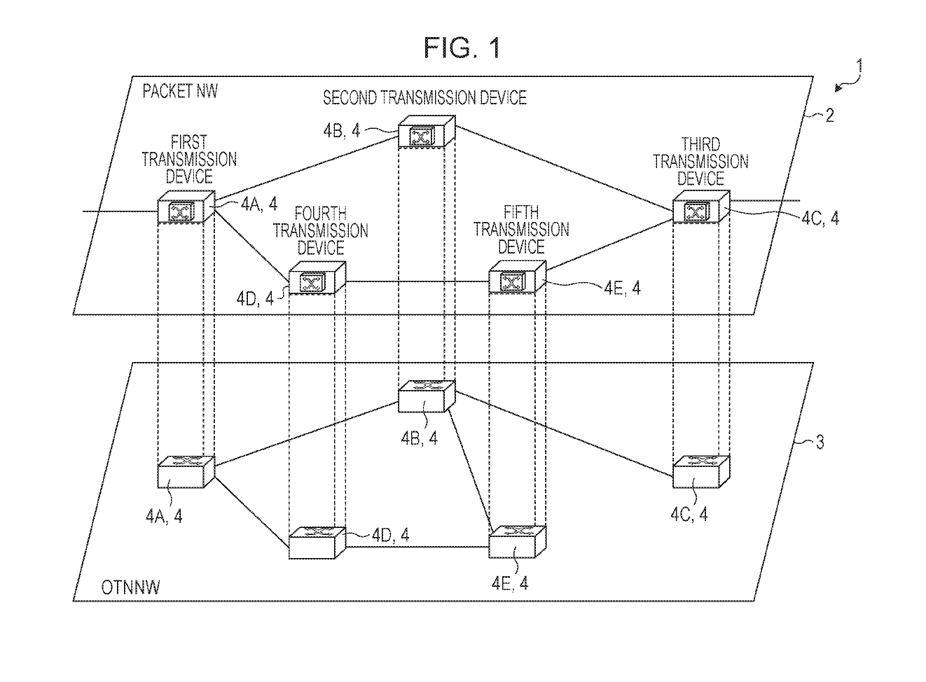

FIG. 1 is a diagram illustrating an example of a transmission system 1 according to an embodiment. The transmission system 1 illustrated in FIG. 1 is a system which includes a packet NW 2 that transmits a frame storing a packet and an OTNNW 3 that transmits an OTN frame and in which each of the packet NW 2 and the OTNNW 3 is formed of an NW having the same topology. The packet NW 2 is an L2 (Layer 2) NW that is configured with connection through a packet path that is a first line through which a frame as a first signal is transmitted. The OTNNW 3 is an L1 (Layer 1) NW that is configured with connection through an OTN path that is a second line through which an OTN frame as a second signal enabling insertion of a packet is transferred.

The transmission system 1 includes a plurality of transmission devices 4, that is, for example, a first transmission device 4A, a second transmission device 4B, a third transmission device 4C, a fourth transmission device 4D, and a fifth transmission device 4E, each of which provides connection between the packet NW 2 and the OTNNW 3 via a corresponding optical fiber 5.

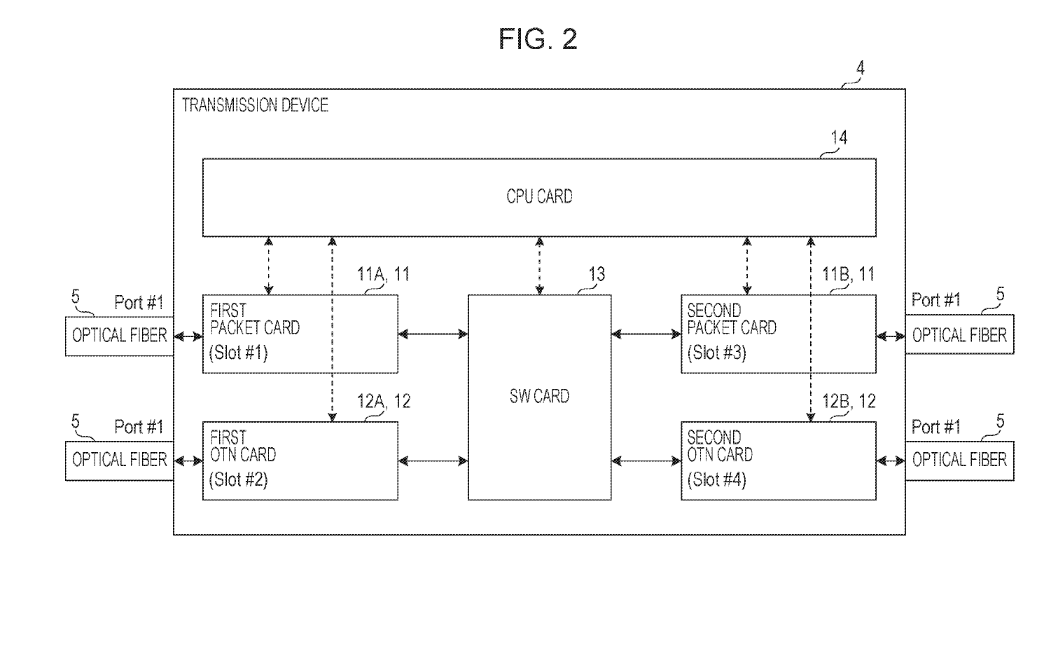

FIG. 2 is a block diagram illustrating an example of a hardware configuration of each of the transmission devices 4. Note that, for convenience of description, the first to fifth transmission devices 4A to 4E will be described as the transmission devices 4 since the first to fifth transmission devices 4A to 4E have the same configuration, the same components are denoted by the same reference character, and the description of redundant configuration and operation thereof will be omitted.

The transmission device 4 illustrated in FIG. 2 includes a plurality of packet cards 11, a plurality of OTN cards 12, an switch (SW) card 13, and a central processing unit (CPU) card 14. Each of the packet cards 11 is a card in which a communication interface with the packet NW 2 is mounted. Note that, for convenience of description, the packet cards 11 are two cards, that is, for example, a first packet card 11A and a second packet card 11B. Each of the OTN cards 12 is a card in which a communication interface with the OTNNW 3 is mounted. Note that, for convenience of description, the OTN cards 12 are two cards, that is, for example, a first OTN card 12A and a second OTN card 12B.

The SW card 13 is a card in which a switch that switches connection between the packet cards 11, between the OTN cards 12, or between one of the packet cards 11 and the corresponding one of the OTN cards 12. The SW card 13 provides connection between the first packet card 11A and the second packet card 11B and transmits a frame through a packet path in the packet NW 2. The SW card 13 provides connection between the first OTN card 12A and the second OTN card 12B and transmits an OTN frame through an OTN path in the OTNNW 3. Also, the SW card 13 switches, for example, connection between the first packet card 11A and the second OTN card 12B or between the second packet card 11B and the first OTN card 12A. The CPU card 14 is a card in which a CPU that controls the entire transmission device 4 is mounted.

In the transmission device 4, the first packet card 11A is loaded in a slot with a slot number #1 and the first OTN card 12A is loaded in a slot with a slot number #2. Furthermore, in the transmission device 4, the second packet card 11B is loaded in a slot with a slot number #3 and the second OTN card 12B is loaded in a slot with a slot number #4.

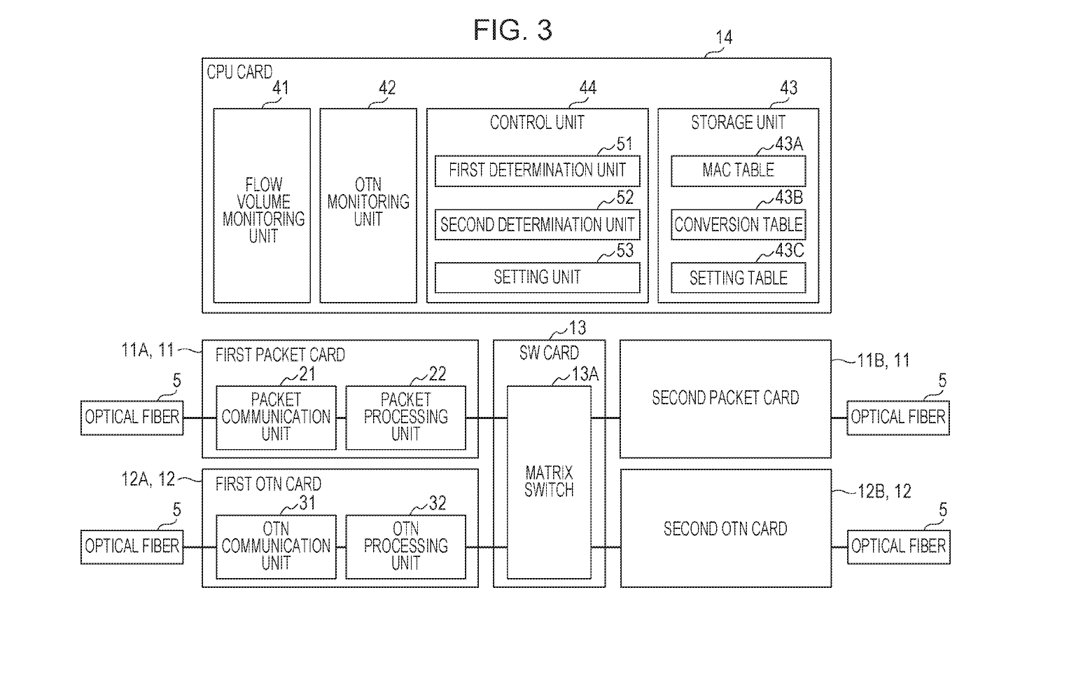

FIG. 3 is a diagram illustrating an example of a functional configuration of the transmission device 4. Each of the packet cards 11 illustrated in FIG. 3 includes a packet communication unit 21 and a packet processing unit 22. The packet communication unit 21 is a communication unit that is coupled to the packet NW 2 and executes packet communication. The packet processing unit 22 is a processing unit that executes packet processing related to various types of packet communication. Each of the OTN cards 12 includes an OTN communication unit 31 and an OTN processing unit 32. The OTN communication unit 31 is a communication unit that is coupled to the OTNNW 3 and executes OTN communication. The OTN processing unit 32 is a processing unit that executes frame processing related to various types of OTN communication. The SW card 13 includes a matrix switch 13A. The matrix switch 13A is a switch that switches connection between the packet processing units 22, between the OTN processing units 32, and one of the packet processing units 22 and the corresponding one of the OTN processing units 32.

The CPU card 14 includes a flow volume monitoring unit 41, an OTN monitoring unit 42, a storage unit 43, and a control unit 44. The flow volume monitoring unit 41 is coupled to the packet communication unit 21 in the packet card 11 and measures the flow volume, that is, the data amount, of a packet for each destination MAC address in a reception frame. The OTN monitoring unit 42 monitors a free space of the OTN path via the OTN communication unit 31. The storage unit 43 includes a MAC table 43A, a conversion table 43B, and a setting table 43C.

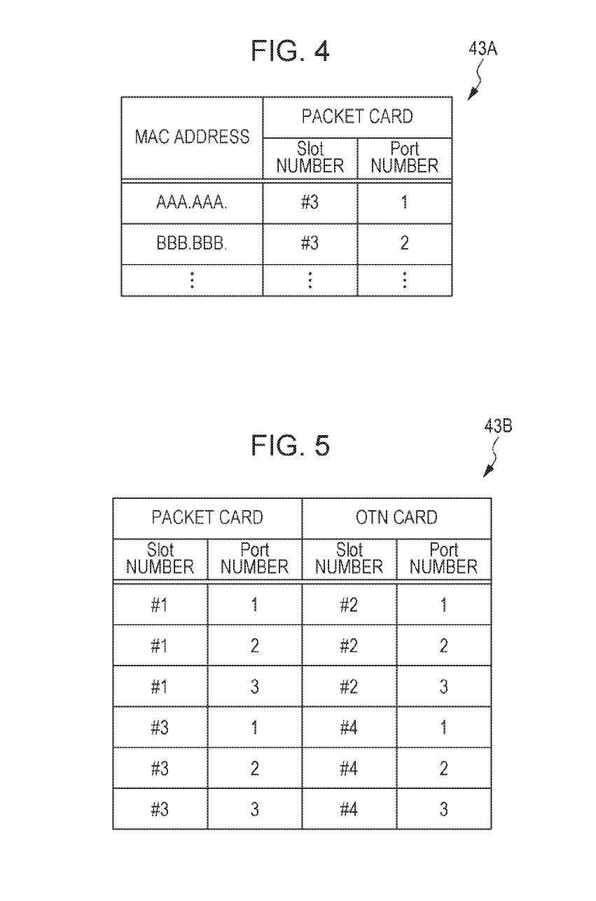

FIG. 4 is a table illustrating an example of the MAC table 43A. The MAC table 43A illustrated in FIG. 4 manages identification information that identifies a transfer destination packet card 11 for each destination MAC address of a packet. Note that the identification information includes, for example, a slot number and a port number of a slot in which the corresponding packet card 11 is loaded. When a destination MAC address in a reception packet is extracted, the control unit 44 refers to the MAC table 43A and recognizes the slot number and the port number of a transfer destination packet card 11 which corresponds to the extracted destination MAC address and to which a corresponding packet is to be transferred.

FIG. 5 is a table illustrating an example of the conversion table 43B. The conversion table 43B illustrated in FIG. 5 is a table that converts information identifying an extracted transfer destination packet card 11 to information identifying a transfer destination OTN card 12. The conversion table 43B manages the slot number and the port number of the transfer destination packet card 11 of a reception packet and the slot number and the port number of the transfer destination OTN card 12 in association with one another. When transferring the reception packet through an OTN path, the control unit 44 refers to the conversion table 43B and recognizes the slot number and the port number of one of the OTN cards 12, which corresponds to the transfer destination packet card 11 of a destination MAC address in the reception packet. The setting table 43C stores various types of information related to the OTN path. Note that, as for a pass checking request, various types of information are, for example, the request number, the ODU type, the transmission source MAC address, the destination MAC address, the reception port number, and the like, thereof.

The control unit 44 controls the entire CPU card 14. The control unit 44 includes a first determination unit 51, a second determination unit 52, and a setting unit 53. The first determination unit 51 determines whether or not the flow volume of a reception packet, which has been measured by the flow volume monitoring unit 41, exceeds a predetermined threshold. When the flow volume of the reception packet exceeds the predetermined threshold, the second determination unit 52 determines whether or not the flow volume of the reception packet is less than the free space of the OTN path that may be set. The setting unit 53 refers to the MAC table 43A and extracts information identifying the transfer destination packet card 11 that corresponds to the destination MAC address of the reception packet. Furthermore, when the flow volume of the reception packet is less than the free space of the OTN path that may be set, the setting unit 53 refers to the conversion table 43B and extracts information identifying the transfer destination OTN card 12 that corresponds to the transfer destination packet card 11. Then, the setting unit 53 sets the transfer destination OTN path via the transfer destination OTN card 12 identified by the extracted information.

When the flow volume of the reception packet is not less than the free space of the OTN path that may be set, the setting unit 53 refers to the MAC table 43A and extracts information identifying the transfer destination packet card 11 that corresponds to the destination MAC address of the reception packet. Then, the setting unit 53 transmits the reception packet through the transfer destination packet path via the transfer destination packet card 11 identified by the extracted information. When the flow volume of the reception packet no longer exceeds the predetermined threshold during the course of transferring the reception packet through the OTN path, the setting unit 53 removes the OTN path that is currently set, switches the transmission path of the reception packet to the packet path of the transfer destination packet card 11, and thus, transmits the reception packet through the packet path.

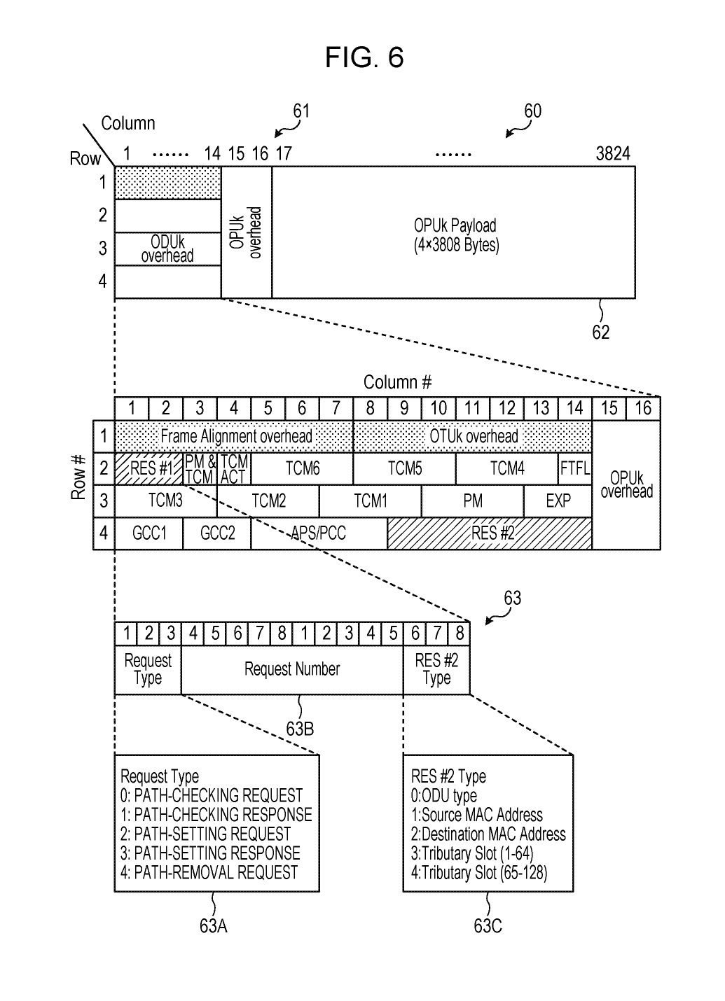

FIG. 6 is a diagram illustrating an example of a format configuration of an OTN frame. An OTN frame 60 illustrated in FIG. 6 includes an OH area 61 and a payload area 62. The OH area 61 is an area which ranges from a first column to a 16th column, has a frame size of 16 bytes×4 rows, and stores various overheads (OH). The payload area 62 is an area which ranges from a 17th column to a 3824th column, has a frame size of 3808 bytes×4 rows, and stores various types of data.

The OH area 61 includes a frame synchronization OH (Frame Alignment OH) in the first to seventh columns in the first row, OTUOH in the eighth to 14th columns in the first row, ODUOH in the first to 14th columns in the second to fourth rows, and OPUOH in the 15th and 16th columns in the first to fourth rows. OTUOH is an OH area of OTU. ODUOH is an OH area of ODU. OPUOH is an OH area of OPU.

The frame synchronization OH includes a frame alignment signal (FAS) and a multi frame alignment signal (MFAS). FAS is a frame synchronization signal. MFAS is a multi frame synchronization signal that detects multi frame synchronization. OTUOH includes fields for section monitoring (SM), general communication channel (GCC) 0, and bytes reserved for future international standardization (RES). SM is information indicating monitor information of OTU end points. GCC 0 is information used for supporting a communication channel between OTU end points.

ODUOH includes fields for RES 63, tandem connection monitoring activation (TCMACT), TCM 1 to TCM 6, fault type & fault location reporting channel (FTFL), path monitoring (PM), and experimental (EXP). Furthermore, ODUOH includes GCC 1 to GCC 2 and automatic protection switching (APS)/protection communication control channel (PCC). TCMACT is information that identifies whether or not tandem connection monitoring is to be activated. FTFL is information used for reporting a fault type and a fault location. PM is information obtained by monitoring a path state. EXP is information that identifies whether or not the frame is for use in test. APS/PCC denotes an automatic reserve switching and switching communication channel.

RES 63 in ODUOH is a reservation area that stores a request type (Request Type) 63A, a request number (Request Number) 63B, and RES 63C. Request Type 63A indicates the type of a request, for example, when a path-checking request is made, Request Type 63A is “0”, and when a path-checking response is made, Request Type 63A is “1”. Also, when a path-setting request is made, Request Type 63A is “2”, when a path-setting response is made, Request Type 63A is “3”, and when a path-removal request is made, Request Type 63A is “4”. RES 63C enables storage of various types of information: when the type of request is the ODU type, Request Type 63A is “0”; when the type of request is a transmission source MAC address, Request Type 63A is “1”; when the type of request is a destination MAC address, Request Type 63A is “2”; when the TS number is 1 to 64, Request Type 63A is “3”; and when the TS number is 65 to 128, Request Type 63A is “4”.

Next, an operation of the transmission system 1 according to this embodiment will be described. When the first transmission device 4A transmits a reception frame to the third transmission device 4C via the packet NW 2, for example, the first transmission device 4A connects with the third transmission device 4C through a packet path that passes through the fourth transmission device 4D and the fifth transmission device 4E, and reaches the third transmission device 4C. As a result, the first transmission device 4A is enabled to transmit a reception frame to the third transmission device 4C via the packet NW 2. Also, when the first transmission device 4A transmits an OTN frame to the third transmission device 4C via the OTNNW 3, for example, the first transmission device 4A connects with the third transmission device 4C through an OTN path that passes through the fourth transmission device 4D and the fifth transmission device 4E, and reaches the third transmission device 4C. As a result, the first transmission device 4A is enabled to transmit the OTN frame to the third transmission device 4C via the OTNNW 3.

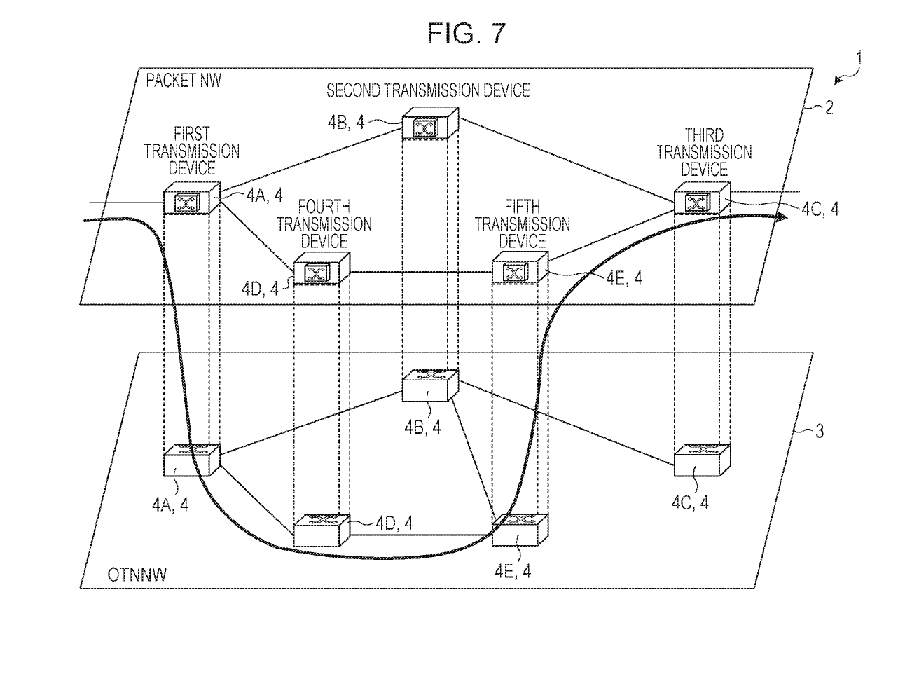

Next, FIG. 7 is a diagram illustrating an example of an operation performed when a reception packet of the packet NW 2 is transferred through an OTN path. When the flow volume of the reception packet exceeds a predetermined threshold and the flow volume of the reception packet is less than the free space of an OTN path that may be set, the first transmission device 4A determines whether or not there is an OTN card 12 that corresponds to a transfer destination packet card 11 of a destination MAC address in the reception packet. When there is the transfer destination OTN card 12, the first transmission device 4A provide the fourth transmission device 4D with a path-setting request in which the destination MAC address in the reception packet is inserted, so as to request the fourth transmission device 4D to set an OTN path reaching the third transmission device 4C, which is the destination of the reception packet, via the OTN card 12.

When the fourth transmission device 4D receives a path-setting request from the first transmission device 4A, the fourth transmission device 4D determines whether or not there is an OTN card 12 that corresponds to a transfer destination packet card 11 of a destination MAC address in the path-setting request. When there is a transmission destination OTN card 12, the fourth transmission device 4D provides the fifth transmission device 4E with a path-setting request in which the destination MAC address in the reception packet is inserted, via the OTN card 12.

When the fifth transmission device 4E receives a path-setting request from the fourth transmission device 4D, the fifth transmission device 4E determines whether or not there is an OTN card 12 that corresponds to a transfer destination packet card 11 of a destination MAC address in the path-setting request. When there is not the transmission destination OTN card 12, the fifth transmission device 4E connects with the third transmission device 4C through a packet path between the fifth transmission device 4E and the third transmission device 4C, via the transfer destination packet card 11 of the destination MAC address.

As a result, the first transmission device 4A transfers the reception packet through the OTN path from the fourth transmission device 4D to the fifth transmission device 4E. Furthermore, the fifth transmission device 4E transmits the reception packet through the packet path reaching the third transmission device 4C.

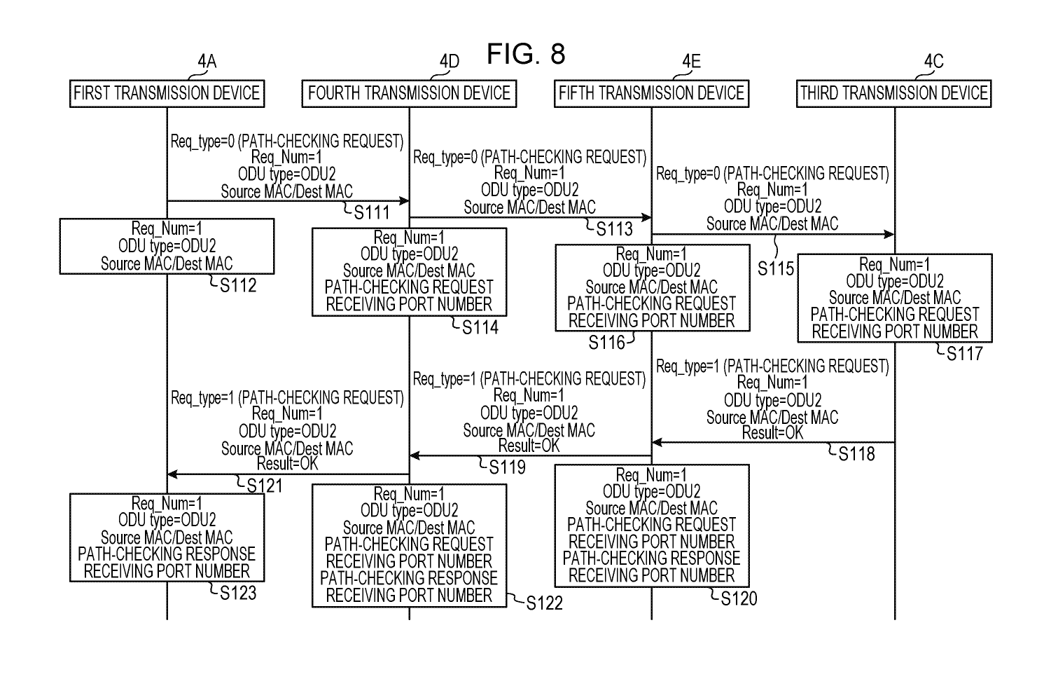

FIG. 8 is an operational sequence illustrating an example of a processing operation of each transmission device 4 related to path checking processing. Note that the path checking processing illustrated in FIG. 8 is processing of checking an OTN path that may be set, for example, from the first transmission device 4A to the third transmission device 4C.

In FIG. 8, when there is an available path bandwidth, the first transmission device 4A transmits a path-checking request to the fourth transmission device 4D via the transfer destination OTN card 12 in order to check a transfer destination OTN path that may be set (Step 5111). Note that the path-checking request is an OTN frame including a request type (Req Type), a request number (Req Num), an ODU type (ODU Type), a transmission source MAC address (Source MAC), and a destination MAC address (Dest MAC). The request type “0” indicates a path-checking request. The request number is a number that identifies a request. The ODU type is a desired use bandwidth type, that is, for example, ODU 2, or the like. The transmission source MAC address is a MAC address that identifies a transmission source in a reception frame. The destination MAC address is a MAC address that identifies a destination of the reception frame. After transmitting the path-checking request to the fourth transmission device 4D, the first transmission device 4A stores the request number, the ODU type, the transmission source MAC address, and the destination MAC address in the path-checking request, in the setting table 43C (Step S112).

When the fourth transmission device 4D receives a path-checking request from the first transmission device 4A, the fourth transmission device 4D determines whether or not there is an available path bandwidth. When there is an available path bandwidth, the fourth transmission device 4D transmits the path-checking request to the fifth transmission device 4E via the transfer destination OTN card 12 (Step S113). The fourth transmission device 4D stores the request number, the ODU type, the transmission source MAC address, and the destination MAC address in the path-checking request, and the reception port number of the path-checking request, in the setting table 43C (Step S114).

When the fifth transmission device 4E receives a path-checking request from the fourth transmission device 4D, the fifth transmission device 4E determines whether or not there is an available path bandwidth. If there is an available path bandwidth, the fifth transmission device 4E transmits the path-checking request to the third transmission device 4C via the transfer destination OTN card 12 (Step S115). The fifth transmission device 4E stores the request number, the ODU type, the transmission source MAC address, and the destination MAC address in the path-checking request, and the reception port number of the path-checking request, in the setting table 43C (Step S116).

When the third transmission device 4C receives a path-checking request from the fifth transmission device 4E, the third transmission device 4C stores the request number, the ODU type, the transmission source MAC address, and the destination MAC address in the path-checking request, and the reception port number of the path-checking request, in the setting table 43C (Step S117). The third transmission device 4C transmits a path-checking response that indicates a checking response of an OTN path between the third transmission device 4C and the first transmission device 4A to the fifth transmission device 4E (Step S118). Note that the path-checking response includes a request type, a request number, an ODU type, a transmission source MAC address, a destination MAC address, and a result of path checking. The request type “1” indicates a path-checking response.

When the fifth transmission device 4E receives a path-checking response, the fifth transmission device 4E transfers the path-checking response to the fourth transmission device 4D via a port that has received the path-checking request (Step S119). Furthermore, when the fifth transmission device 4E receives a path-checking response from the third transmission device 4C, the fifth transmission device 4E stores the reception port number of the path-checking response, which identifies the port that has received the path-checking response, in the setting table 43C (Step S120). When the fourth transmission device 4D receives a path-checking response, the fourth transmission device 4D transmits the path-checking response to the first transmission device 4A via a port that has received the path-checking request (Step S121). Furthermore, when the fourth transmission device 4D receives a path-checking response from the fifth transmission device 4E, the fourth transmission device 4D stores the reception port number of the path-checking response, which identifies the port that has received the path-checking response, in the setting table 43C (Step S122). Furthermore, when the first transmission device 4A receives a path-checking response from the fourth transmission device 4D, the first transmission device 4A stores the reception port number of the path-checking response, which identifies the port that has received the path-checking response, in the setting table 43C (Step S123).

The path checking processing illustrated in FIG. 8 allows checking an OTN path that may be set between the transmission devices 4, in response to a response to a path-checking request between the transmission devices 4.

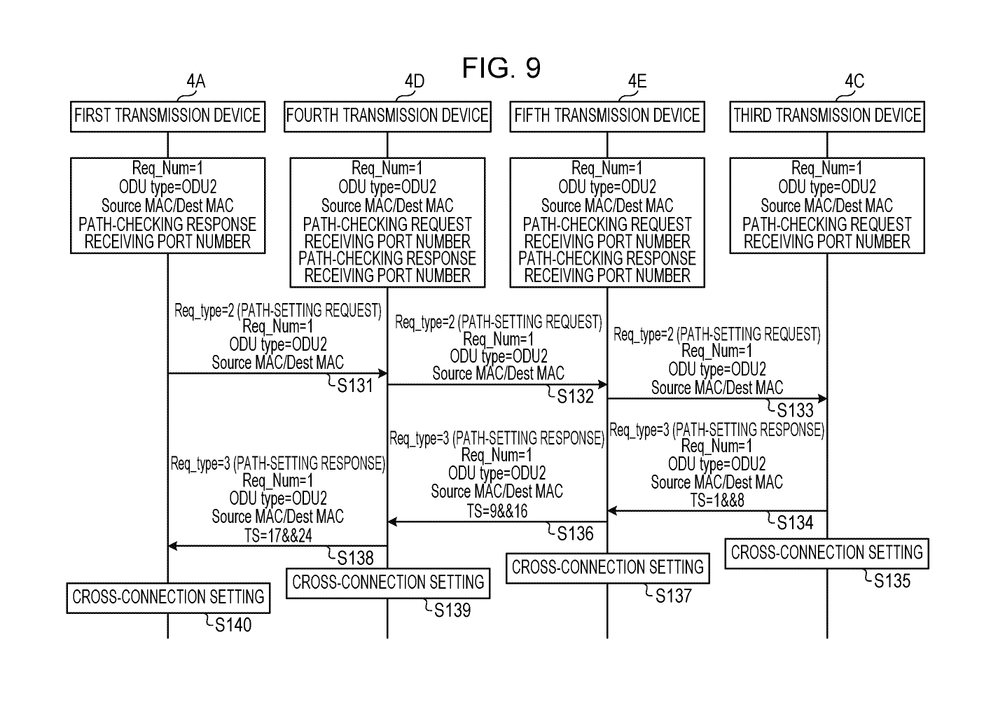

FIG. 9 is an operational sequence illustrating an example of a processing operation of each transmission device 4 related to path setting processing. Note that the path setting processing illustrated in FIG. 9 is processing of setting an OTN path after a path-checking response is transmitted and received between the first transmission device 4A and the third transmission device 4C.

The first transmission device 4A stores the request number, the ODU type, the transmission source MAC address, the destination MAC address, and the reception port number of a path-checking response which are related to path checking, in the setting table 43C. The fourth transmission device 4D stores the request number, the ODU type, the transmission source MAC address, the destination MAC address, the reception port number of a path-checking request, and the reception port number of a path-checking response which are related to path checking, in the setting table 43C. The fifth transmission device 4E stores the request number, the ODU type, the transmission source MAC address, the destination MAC address, the reception port number of a path-checking request, and the reception port number of a path-checking response which are related to path checking, in the setting table 43C. The third transmission device 4C stores the request number, the ODU type, the transmission source MAC address, the destination MAC address, and the reception port number of a path-checking request which are related to path checking, in the setting table 43C.

In FIG. 9, the first transmission device 4A refers to the reception port number of a path-checking response that is currently stored in the setting table 43C and transmits a path-setting request to the fourth transmission device 4D by using the port identified by the reception port number (Step S131). Note that the path-setting request is an OTN frame that includes the request type, the request number, the ODU type, the transmission source MAC address, and the destination MAC address. The request type “2” indicates a path-setting request.

When the fourth transmission device 4D receives a path-setting request from the first transmission device 4A, the fourth transmission device 4D refers to the reception port number of the path-checking response that is currently stored in the setting table 43C and transmits the path-setting request to the fifth transmission device 4E by using the port identified by the reception port number (Step S132). When the fifth transmission device 4E receives a path-setting request from the fourth transmission device 4D, the fifth transmission device 4E refers to the reception port number of the path-checking request that is currently stored in the setting table 43C and transmits the path-setting request to the third transmission device 4C by using the port identified by the reception port number (Step S133).

When the third transmission device 4C receives a path-setting request from the fifth transmission device 4E, the third transmission device 4C refers to the reception port number of the path-checking request that is currently stored in the setting table 43C and transmits the path-setting response to the fifth transmission device 4E by using the port identified by the reception port number (Step S134). The third transmission device 4C sets a cross-connection between the first OTN card 12A that provides connection to the fifth transmission device 4E and the second packet card 11B (Step S135). Note that the path-setting request is an OTN frame that includes the request type, the request number, the ODU type, the transmission source MAC address, the destination MAC address, and the TS number. The request type “3” indicates a path-setting response. The TS number is a number that identifies a tributary slot (TS) that is used for an OTN path.

When the fifth transmission device 4E receives a path-setting response from the third transmission device 4C, the fifth transmission device 4E refers to the reception port number of the path-checking request that is currently stored in the setting table 43C and transmits the path-setting response to the fourth transmission device 4D by using the port identified by the reception port number (Step S136). The fifth transmission device 4E sets a cross-connection between the second OTN card 12B that provides connection to the third transmission device 4C and the first OTN card 12A that provides connection to the fourth transmission device 4D (Step S137). When the fourth transmission device 4D receives a path-setting response from the fifth transmission device 4E, the fourth transmission device 4D refers to the reception port number of the path-checking request that is currently stored in the setting table 43C and transmits the path-setting response to the first transmission device 4A by using the port identified by the reception port number (Step S138). The fourth transmission device 4D sets a cross-connection between the second OTN card 12B that provides connection to the fifth transmission device 4E and the first OTN card 12A that provides connection to the first transmission device 4A (Step S139). Furthermore, when the first transmission device 4A receives the path-setting response from the fourth transmission device 4D, the first transmission device 4A sets a cross-connection between the second OTN card 12B that provides connection to the third transmission device 4C and the first packet card 11A (Step S140) and terminates the processing operation illustrated in FIG. 9. As a result, the first transmission device 4A sets a cross-connection in each of the transmission devices 4 between the first transmission device 4A and the third transmission device 4C, thereby automatically setting an OTN path between the first transmission device 4A and the third transmission device 4C.

By performing the path setting processing illustrated in FIG. 9, an OTN path may be automatically set in accordance with a response to a request for setting an OTN path after a path-checking response is transmitted and received between the first transmission device 4A and the third transmission device 4C.

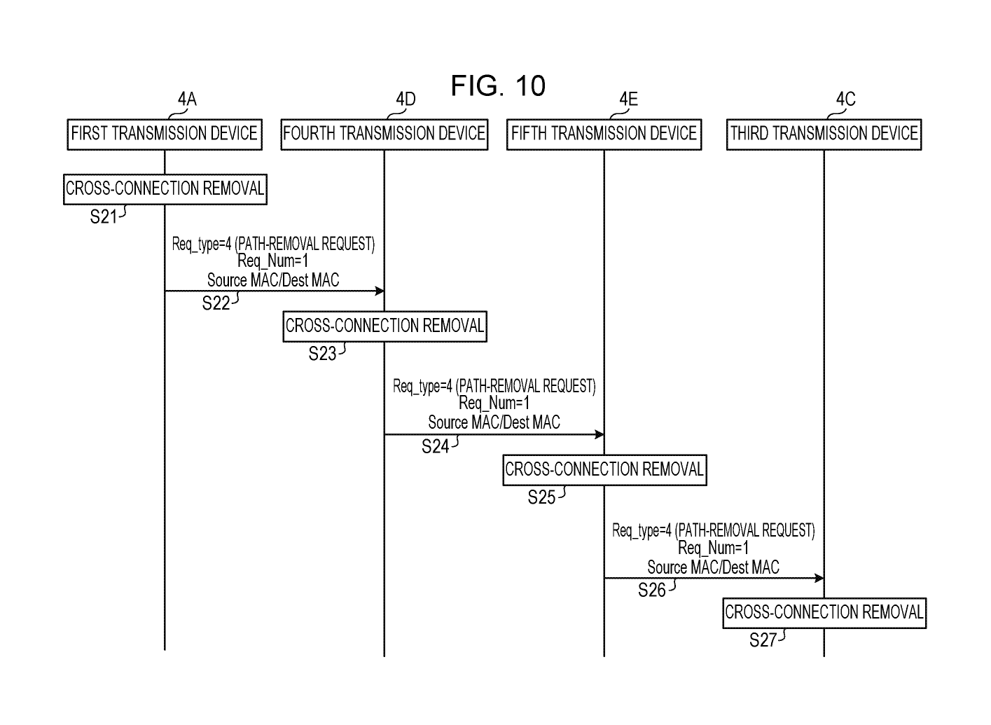

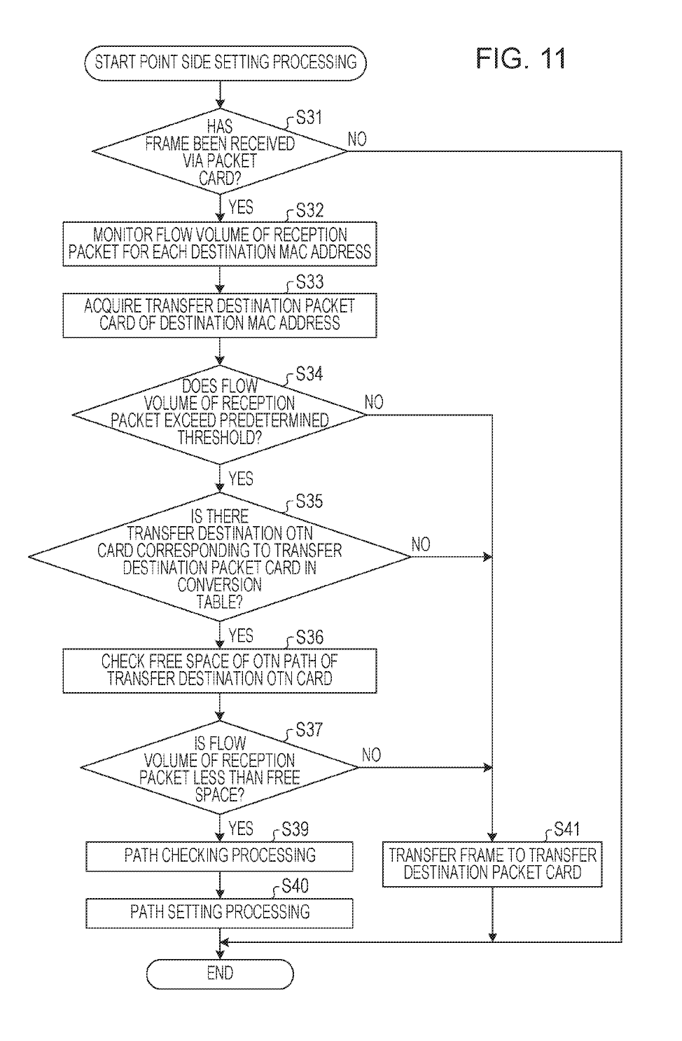

FIG. 10 is an operational sequence illustrating an example of a processing operation of each transmission device 4 related to path removal processing. Note that the path removal processing illustrated in FIG. 10 is processing of removing each cross-connection between the first transmission device 4A and the third transmission device 4C and thus removing an OTN path between the first transmission device 4A and the third transmission device 4C.

In FIG. 10, for example, when the flow volume of the reception frame no longer exceeds the predetermined threshold during the course of transferring a reception packet through an OTN path, the first transmission device 4A removes a cross-connection of the OTN path that is currently set (Step S21). Then, when the first transmission device 4A removes a cross-connection between the first packet card 11A and the second OTN card 12B, the first transmission device 4A transmits a path-removal request to the fourth transmission device 4D (Step S22). Note that the path-removal request is an OTN frame that includes the request type, the request number, the transmission source MAC address, and the destination MAC address. The request type “4” indicates a path-removal request.

When the fourth transmission device 4D receives a path-removal request from the first transmission device 4A, the fourth transmission device 4D removes a cross-connection between the first OTN card 12A and the second OTN card 12B (Step S23) and the fourth transmission device 4D transmits the path-removal request to the fifth transmission device 4E (Step S24). When the fifth transmission device 4E receives a path-removal request from the fourth transmission device 4D, the fifth transmission device 4E removes a cross-connection between the first OTN card 12A and the second OTN card 12B (Step S25) and transmits the path-removal request to the third transmission device 4C (Step S26). When the third transmission device 4C receives a path-removal request from the fifth transmission device 4E, the third transmission device 4C removes a cross-connection between the first OTN card 12A and the second packet card 11B (Step S27). As a result, the first transmission device 4A removes a cross-connection of each of the transmission devices 4 between the first transmission device 4A and the third transmission device 4C, thereby removing the OTN path between the first transmission device 4A and the third transmission device 4C.

By performing the path removal processing illustrated in FIG. 10, each cross-connection of an ONT path that is currently set between the transmission devices 4 may be sequentially removed, and thus, the OTN path may be removed.

FIG. 11 is an operational flowchart illustrating an example of a processing operation of each transmission device 4 related to start point side setting processing. Note that it is assumed that the first transmission device 4A is a start point and the third transmission device 4C is an end point. In FIG. 11, the control unit 44 in the transmission device 4 determines whether or not a frame has been received from the packet NW 2 via the corresponding packet card 11 (Step S31). When a frame has been received (YES in Step S31), the control unit 44 monitors the flow volume of a reception packet for each destination MAC address in a reception frame (Step S32).

The control unit 44 refers to the MAC table 43A and extracts information identifying a transfer destination packet card 11 that corresponds to a destination MAC address of the reception packet (Step S33). Furthermore, the control unit 44 causes the first determination unit 51 to determine whether or not the flow volume of the reception packet exceeds the predetermined threshold (Step S34). When the flow volume of the reception packet exceeds the predetermined threshold (YES in Step S34), the control unit 44 causes the setting unit 53 to determine whether or not there is a transfer destination OTN card 12 that corresponds to the transfer destination packet card 11, with reference to the conversion table 43B (Step S35).

When there is the transfer destination OTN card 12 (YES in Step S35), the control unit 44 checks the free space of the OTN path that is related to the transfer destination OTN card 12 and may be set (Step S36). The control unit 44 determines whether or not the flow volume of the reception packet is less than the free space of the OTN path that is related to the transfer destination OTN card 12 and may be set in the second determination unit 52 (Step S37).

When the flow volume of the reception packet is less than the free space of the OTN path that may be set (YES in Step S37), the control unit 44 executes path checking processing so as to check an ONT path that may be set as a transfer destination of the reception packet (Step S39). Note that, in the path checking processing, an OTN path that may be set is checked by confirming that a path-checking request is transmitted and then a path-checking response to the path-checking request is received. For example, processing of each of Steps S111, S112, S121, S123, and the like, illustrated in FIG. 8, is executed.

Furthermore, after an OTN path that may be set is checked in the path checking processing, the control unit 44 executes path setting processing so as to set the OTN path that may be set as a transfer destination of the reception frame (Step S40), and terminates the processing operation illustrated in FIG. 11. Note that, in the path setting processing, an OTN path may be set when a path-setting request has been transmitted and then a path-setting response to the path-setting request has been received. For example, processing of each of Steps S131, S138, S140, and the like, illustrated in FIG. 9, is executed. As a result, the transmission device 4 may transfer a reception frame through an ONT path of the OTNNW 3, which is currently set.

When the control unit 44 has not received a frame via the corresponding packet card 11 (NO in Step S31), the control unit 44 terminates the processing operation illustrated in FIG. 11. When the flow volume of the reception packet does not exceed the predetermined threshold (NO in Step S34), the control unit 44 transfers the reception frame to the transfer destination packet card 11 (Step S41) and terminates the processing operation illustrated in FIG. 11. As a result, the transmission device 4 may transmit the reception frame through a packet path of the packet NW 2.

When there is not a transfer destination OTN card that corresponds to the transfer destination packet card 11 (NO in Step S35), in order to transfer the reception frame to the transfer destination packet card 11, the control unit 44 causes the process to proceed to Step S41. When the flow volume of the reception packet is not less than the free space (NO in Step S37), in order to transfer the reception frame to the transfer destination packet card 11, the control unit 44 causes the process to proceed to Step S41.

In FIG. 11, the transmission device 4 determines whether or not the flow volume of the reception packet exceeds the predetermined threshold and there is a transfer destination OTN card 12 that corresponds to the packet card 11 of the destination MAC address of the reception packet. When there is a transfer destination OTN card, the transmission device 4 determines whether or not the flow volume of the reception packet is less than the free space of an OTN path. Then, when the flow volume of the reception packet is less than the free space of the OTN path, the transmission device 4 sets an OTN path via the transfer destination OTN card 12. As a result, when the flow volume of the reception packet exceeds the predetermined threshold, the transmission device 4 may transfer the reception packet through the ONT path.

When there is not a transfer destination OTN card 12 that corresponds to the packet card 11 of the destination MAC address of the reception packet, the transmission device 4 transmits the reception packet through a packet path via the transfer destination packet card 11. As a result, when there is not a transfer destination OTN card 12, the transmission device 4 may transmit the reception packet through the packet path.

When the flow volume of the reception packet does not exceed the predetermined threshold, the transmission device 4 transmits the reception packet via the transfer destination packet card 11 that corresponds to the destination MAC address in the reception packet. As a result, when the flow volume of the reception packet does not exceed the predetermined threshold, the transmission device 4 may transmit the reception packet through a packet path.

When the flow volume of the reception packet is not less than the free space of the OTN path, the transmission device 4 transmits the reception packet via the transfer destination packet card 11. As a result, the transmission device 4 may transmit the reception packet through a packet path.

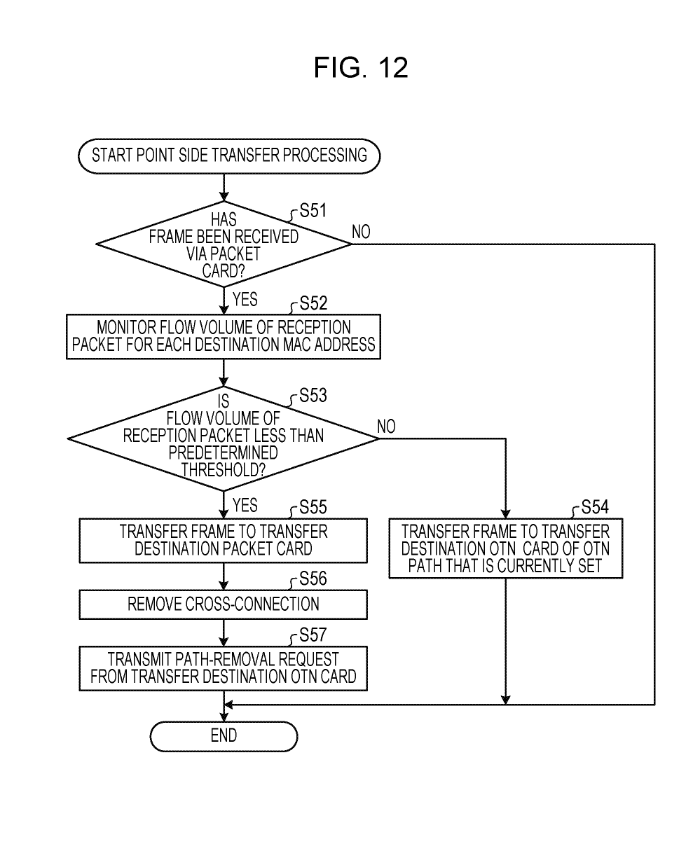

FIG. 12 is an operational flowchart illustrating an example of a processing operation of each transmission device 4 related to start point side transfer processing. Note that, for convenience of description, it is assumed that the transmission device 4 transfers a reception packet through an OTN path.

In FIG. 12, the control unit 44 in the transmission device 4 determines whether or not a reception frame has been received via the corresponding packet card 11 (Step S51). When a reception frame has been received (YES in Step S51), the control unit 44 monitors the flow volume of the reception packet for each destination MAC address in the reception frame (Step S52)

The control unit 44 determines whether or not the flow volume of the reception packet for each destination MAC address is less than the predetermined threshold (Step S53). When the flow volume of the reception packet for each destination MAC address is not less than the predetermined threshold (NO in Step S53), the control unit 44 transfers the reception packet to a transfer destination OTN card 12 related to the OTN path that is currently set (Step S54) and terminates the processing operation illustrated in FIG. 12.

When the flow volume of the reception packet is less than the predetermined threshold (YES in Step S53), the control unit 44 refers to the MAC table 43A and transfers the reception packet to the transfer destination packet card 12 that corresponds to the destination MAC address of the reception packet (Step S55). Furthermore, the control unit 44 removes a cross-connection that has been set for transferring the reception frame (Step S56), transmits a path-removal request from the transfer destination OTN card 12 (Step S57), and terminates the processing operation illustrated in FIG. 12. When the control unit 44 has not received the reception frame via the corresponding packet card 11 (NO in Step S51), the control unit 44 terminates the processing operation illustrated in FIG. 12.

In FIG. 12, when the flow volume of the reception packet becomes less than the predetermined threshold during the course of transferring reception packets through the OTN path that is currently set, the transmission device 4 removes a cross-connection in the OTN path that is currently set. Then, the transmission device 4 transmits the reception packet via the transfer destination packet card 11 through a packet path. As a result, when the flow volume of the reception packet becomes less than the predetermined threshold, the transmission device 4 transmits the reception packet by switching the transmission path of the reception packet to a normal packet path, thereby reducing the amount of traffic to the OTNNW 3.

When the flow volume of the reception packet has not become less than the predetermined threshold during the course of transferring the reception packet through the OTN path that is currently set, the transmission device 4 transfers the reception packet through the OTN path that is currently set. As a result, the transmission device 4 may continuously transfer the reception packet through the OTN path that is currently set.

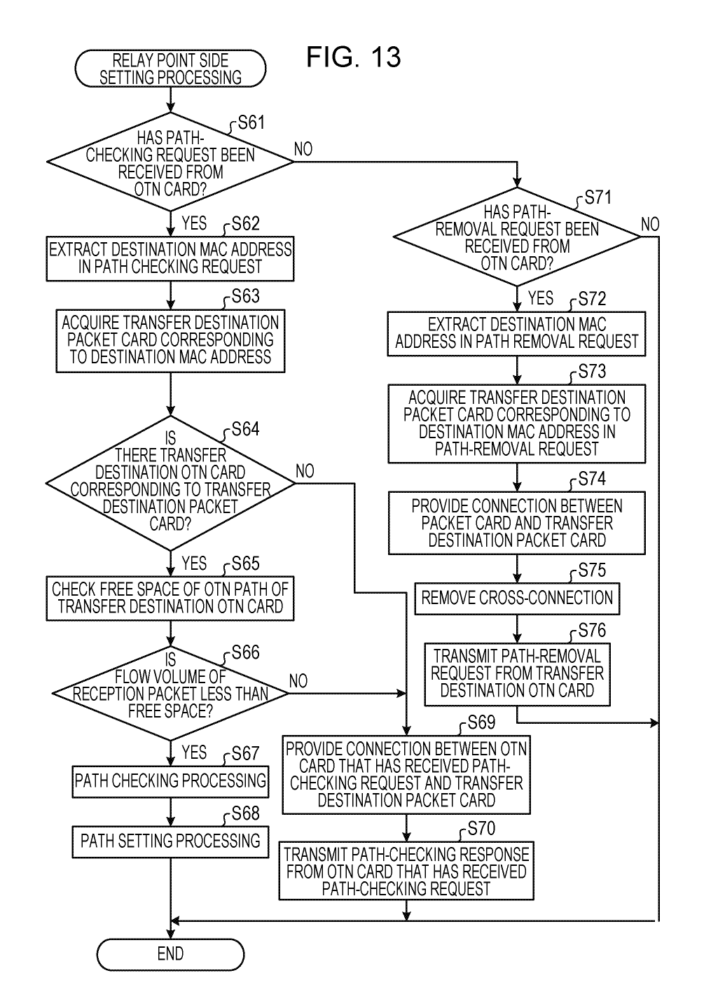

FIG. 13 is an operational flowchart illustrating an example of a processing operation of each transmission device 4 related to relay point side setting processing. Note that, assuming that the first transmission device 4A is a start point and the third transmission device 4C is an end point, the transmission devices 4 located in relay points are, for example, the fourth transmission device 4D and the fifth transmission device 4E.

In FIG. 13, the control unit 44 in the transmission device 4 determines whether or not a path-checking request has been received from the corresponding OTN card 12 (Step S61). When a path-checking request has been received (YES in Step S61), the control unit 44 extracts a destination MAC address in the path-checking request (Step S62).

The control unit 44 refers to the MAC table 43A and extracts information identifying a transfer destination packet card 11 that corresponds to the destination MAC address (Step S63). The control unit 44 refers to the conversion table 43B and determines whether or not there is a transfer destination OTN card 12 that corresponds to the transfer determination packet card 11 identified by the extracted information (Step S64).

When there is a transfer destination OTN card 12 that corresponds to the transfer destination packet card 11 (YES in Step S64), the control unit 44 checks the free space of an OTN path that is related to the transfer destination OTN card 12 (Step S65). The control unit 44 determines whether or not the flow volume of the reception packet is less than the free space of the OTN path that may be set (Step S66).

When the flow volume of the reception packet is less than the free space of the OTN path that may be set (YES in Step S66), in order to check the OTN path that may be set, the control unit 44 executes path checking processing (Step S67). Note that, in the path checking processing, an OTN path that may be set may be checked when a path-checking request is transmitted and a path-checking response to the path-checking request is received. For example, processing of each of Steps S113, S114, S119, S122, and the like, illustrated in FIG. 8, is executed.

After the control unit 44 checks an OTN path that may be set in the path checking processing, the control unit 44 executes path setting processing so as to set the OTN path that may be set as a transfer destination of the reception frame (Step S68), and terminates the processing operation illustrated in FIG. 13. Note that, in the path setting processing, an OTN path may be set when a path-setting request has been transmitted and then a path-setting response to the path-setting request has been received. For example, processing of each of Steps S132, S136, S139, and the like, illustrated in FIG. 9, is executed. As a result, the transmission device 4 may transfer the reception frame through an OTN path of the OTNNW 3, which is currently set.

When there is not a transfer destination OTN card 12 that corresponds to the transfer destination packet card 11 (NO in Step S64), the control unit 44 provides connection between the OTN card 12 that has received a path-setting request and the transfer destination packet card 11 (Step S69). Furthermore, the control unit 44 sets the TS number in the path-setting response, transmits the path-setting response via the OTN card 12 that has received the path-setting request (Step S70), and terminates the processing operation illustrated in FIG. 13.

When the free space is not more than the flow volume of the reception frame (NO in Step S66), in order to provide connection between the OTN card 12 that has received the path-setting request and the transfer destination packet card 11, the control unit 44 causes the process to proceed to Step S69.

When the control unit 44 has not received a path-setting request from the corresponding OTN card 12 (NO in Step S61), the control unit 44 determines whether or not a path-removal request has been received from the OTN card 12 (Step S71). When the control unit 44 has received a path-removal request (YES in Step S71), the control unit 44 extracts a MAC address in the path-removal request (Step S72). Furthermore, the control unit 44 refers to the MAC table 43A and extracts information identifying a transfer destination packet card 11 that corresponds to the MAC address in the path-removal request (Step S73).

The control unit 44 provides connection between the packet card 11 and the transfer destination packet card 11 (Step S74) and removes a cross-connection (Step S75). Then, the control unit 44 transmits a path-removal request from the OTN card 12, which has been set before the cross-connection is removed (Step S76), and terminates the processing operation illustrated in FIG. 13. When the control unit 44 has not received a path-removal request (NO in Step S71), the control unit 44 terminates the processing operation illustrated in FIG. 13.

In FIG. 13, when the transmission device 4 has received a path-checking request, the transmission device 4 determines whether or not there is a transfer destination OTN card 12 that corresponds to the packet card 11 of the destination MAC address of the reception packet in the path-checking request. When there is the transfer destination OTN card 12, the transmission device 4 determines whether or not the flow volume of the reception packet is less than the free space of an OTN path that may be set. Then, when the flow volume of the reception packet is less than the free space of the OTN path that may be set, the transmission device 4 checks the OTN path that may be set via the transfer destination OTN card 12. Then, when the transmission device 4 has received a path-setting response to the path-setting request of an OTN path that may be set, the transmission device 4 sets an OTN path. As a result, the transmission device 4 may set an OTN path through which the reception packet is transferred.

When there is not a transfer destination OTN card 12 that corresponds to the packet card 11 of the destination MAC address of the reception packet, the transmission device 4 provides connection to the packet card 11 as a transfer destination. As a result, when there is not the transfer destination OTN card 12, the transmission device 4 may relay the reception packet that has been received through the OTN path, through a packet path.

When the flow volume of the reception packet is not less than the free space of the OTN path that may be set, the transmission device 4 provides connection to the packet card 11 as a transfer destination. As a result, the transmission device 4 may relay the reception packet that has been received through the OTN path to the transfer destination through a packet path.

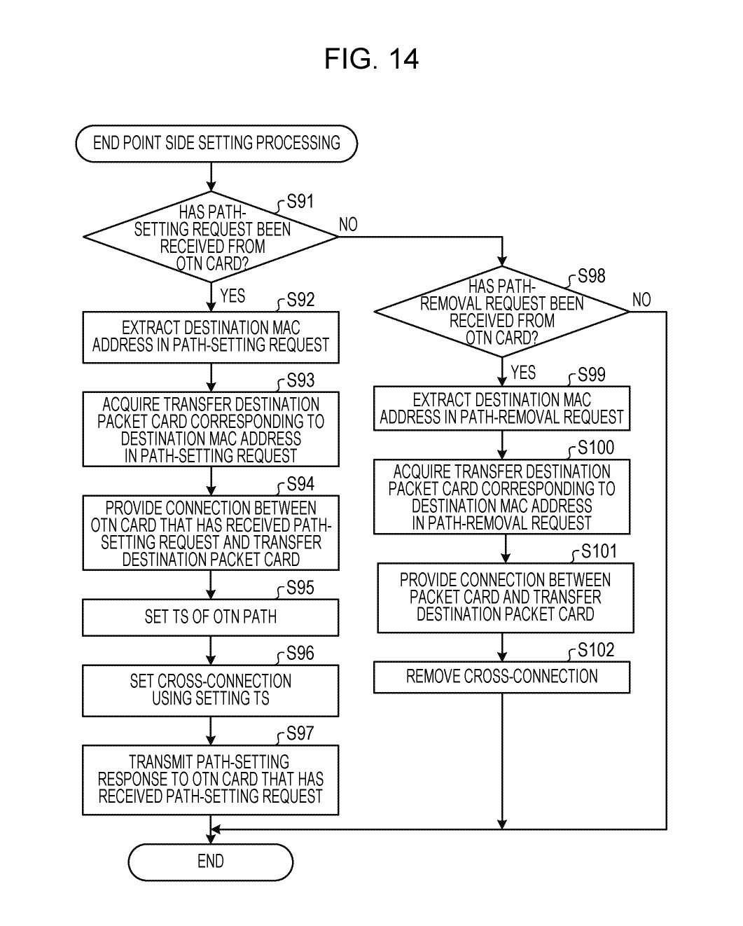

FIG. 14 is an operational flowchart illustrating an example of a processing operation of each transmission device 4 related to end point side setting processing. Note that, for example, it is assumed that one of the transmission devices 4, which is an end point transmission device 4, is the third transmission device 4C.

In FIG. 14, the control unit 44 in the transmission device 4 determines whether or not a path-setting request has been received from the corresponding OTN card 12 (Step S91). When a path-setting request has been received (YES in Step S91), the control unit 44 extracts a destination MAC address in the path-setting request (Step S92).

The control unit 44 refers to the MAC table 43A and extracts information identifying a transfer destination packet card 11 that corresponds to the destination MAC address (Step S93). The control unit 44 provides connection between the OTN card 12 that has received the path-setting request and the transfer destination packet card 11 (Step S94) and sets the TS number of an OTN path (Step S95).

Furthermore, the control unit 44 sets a cross-connection by using a setting TS number (Step S96), sets the TS number in a path-setting response, transmits the path-setting response from the OTN card 12 that has received the path-setting request (Step S97), and terminates the processing operation illustrated in FIG. 14.

When a path-setting request has not been received from the corresponding OTN card 12 (NO in Step S91), the control unit 44 determines whether or not a path-removal request has been received from the corresponding OTN card 12 (Step S98). When a path-removal request has been received (YES in Step S98), the control unit 44 extracts a MAC address in the path-removal request (Step S99). Furthermore, the control unit 44 refers to the MAC table 43A and extracts information identifying a transfer destination packet card 11 that corresponds to the MAC address in the path-removal request (Step S100).

The control unit 44 provides connection between the packet card 11 and the transfer destination packet card 11 (Step S101), removes a cross-connection (Step S102), and terminates the processing operation illustrated in FIG. 14. When a path-removal request has not been received from the corresponding OTN card 12 (NO in Step S98), the control unit 44 terminates the processing operation illustrated in FIG. 14.

In FIG. 14, when the end point transmission device 4 receives a path-setting request, the transmission device 4 sets a cross-connection in accordance with the path-setting request and sends back a path-setting response. The end point transmission device 4 sequentially sets a cross-connection with another one of the transmission devices 4, which is located at an opposite side the end point transmission device 4, and sets an ONT path. As a result, the transmission devices 4 may automatically set an OTN path.

When the end point transmission device 4 receives a path-removal request, the transmission device 4 removes a cross-connection that is currently set, in accordance with the path-removal request. As a result, the transmission devices 4 may remove an ONT path that is currently set.

When the flow volume of the reception packet exceeds the predetermined threshold, in order to transfer the reception packet, the transmission device 4 according to this embodiment sets an OTN path, based on the destination MAC address in the reception packet. As a result, even when the flow volume of the reception packet has increased, the transmission device 4 may automatically set an ONT path and transfer the reception packet through the OTN path. For example, when there is a shortage of path on the packet NW 2 side, an OTN path may make up for the capacity shortage. Furthermore, even when the number of the transmission devices 4 in the transmission system 1 has increased, the processing load of OTN path automatic setting may be reduced, as compared to a related technology.

The transmission device 4 inserts a destination MAC address in a reception packet into an OTN frame, requests for setting of an OTN path, based on the destination MAC address in the OTN frame, and sets an OTN path in accordance with a response that corresponds to the setting request. As a result, the transmission device 4 may set the OTN path by using the destination MAC address in the reception packet.

When the flow volume of a reception packet exceeds the predetermined threshold and the flow volume of the reception packet is less than the free space of an OTN path, in order to transfer the reception packet, the transmission device 4 sets the OTN path, based on the destination MAC address in the reception packet. As a result, the transmission device 4 may transfer the reception packet through the OTN path.

The transmission device 4 measures the flow volume of a reception packet for each destination MAC address in a reception frame. As a result, the transmission device 4 may recognize the flow volume of each reception packet.

When the flow volume of the reception packet no longer exceeds the predetermined threshold in the corresponding packet card 11, in a state where an OTN path to which the reception packet is to be transferred is being set based on the destination MAC address in the reception packet, the transmission device 4 switches the transmission path of the reception packet from the OTN path to a packet path. As a result, the transmission device 4 may reduce the amount of traffic to the OTNNW 3.

Note that, in the above-described embodiment, when the flow volume of a reception packet exceeds the predetermined threshold, a transfer destination OTN card 12 that corresponds to the transfer destination packet card 11 of the destination MAC address in the reception packet is extracted, and an ONT path is automatically set via the extracted transfer destination OTN card 11. As a method for automatically setting an OTN path, for example, an OTN path may be automatically set using GMPLS, such as a neighbor discovery function, a topology table function, a path computation function, a signaling function, and the like. The neighbor discovery function is a function of recognizing a link in the OTNNW 3 by using, for example, a LMP protocol. The topology table function is a function of generating topology information in the OTNNW 3 by using, for example, an OSPF-TE protocol. The path computation function is a function of retrieving a shortest path to a destination by using, for example, the topology information generated in accordance with OSPF-TE and a constraint shortest path fast (CSPF) algorithm. The signaling function is a function of setting an OTN path from an end to an end from the shortest path information by using a RSVP-TE protocol.

However, although an OTN path may be automatically set using GMPLS, in addition to that, it is desired to calculate, after recognizing the topology of the entire OTNNW 3 by OSPF-TE, a shortest path. Since it is desired that all of the transmission devices 4 provided in the OTNNW 3 recognize the topologies of all of links in the OTNNW 3, in order to recognize topology information on a real-time basis, the processing load of the OSPF-TE protocol is increased. Moreover, as the number of the transmission devices 4 in the OTNNW 3 increases, the processing load of OSPF-TE and the processing load of the shortest path increase. In this embodiment, in contrast, an OTN path may be automatically set without using GMPLS, and therefore, the processing load of automatic setting may be reduced.

Although, in the above-described embodiment, the transmission system 1 configured such that the packet NW 2 and the OTNNW 3 have the same topology has been described as an example, even when the transmission system 1 is not configured such that the packet NW 2 and the OTNNW 3 are configured to have the same topology, an OTN path may be automatically set.

Although, in the above-described embodiment, as the packet NW 2, an Ethernet (registered trademark) NW has been described as an example, the packet NW 2 is not limited thereto, but any NW having a destination MAC address in a packet may be appropriately used.

Also, each component element of each unit illustrated in the drawings may not be physically configured as illustrated in the drawings. That is, specific embodiments of disintegration and integration of each unit are not limited to those illustrated in the drawings, and all or some of the units may be disintegrated and integrated functionally or physically in an arbitrary unit in accordance with various loads, use conditions, and the like.

Furthermore, the whole or a part of each processing function performed by each device may be executed on a central processing unit (CPU) (or a microcomputer, such as a micro processing unit (MPU), a micro controller unit (MCU), and the like). Also, it is needless to say that the whole or a part of each processing function may be executed on a program that is analyzed and executed by the CPU (or the microcomputer, such as MPU, MCU, and the like) or on a hardware of a wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmission device comprising:
a plurality of first cards each being coupled to a first line through which a first signal is transmitted;
a second card coupled to a second line through which a second signal enabling insertion of the first signal is transmitted; and
a processor configured to:
determine whether or not a data amount of the first signal exceeds a predetermined threshold in the first card, and
when the data amount of the first signal exceeds the predetermined threshold, cause the second card to set, based on destination information in the first signal, the second line through which the first signal is to be transferred.

2. The transmission device of claim 1, wherein
the processor is further configured to determine, when the data amount of the first signal exceeds the predetermined threshold, whether or not the data amount of the first signal is less than a free space of the second line; and
when it is determined that the data amount of the first signal is less than the free space of the second line, the processor causes the second card to set, based on the destination information in the first signal, the second line to transfer the first signal.

3. The transmission device of claim 1, wherein the processor:
inserts the destination information in the first signal into the second signal,
transmits a setting request related to the second signal to which the destination information of the first signal has been inserted, to an opposed transmission device, and
sets, upon receiving a response to the setting request from the opposed transmission device, the second line through which the first signal is to be transferred.

4. The transmission device claim 1, wherein
the processor is configured to monitor the data amount of the first signal of the first line for each destination information in the first signal.

5. The transmission device of claim 1, wherein
when the processor determines that the data amount of the first signal no longer exceeds the predetermined threshold in a state where the second line is being set based on the destination information in the first signal so as to transfer the first signal, the processor sets the first signal in the first line so as to switch the first signal from the second line to the first line.

6. The transmission device of claim 1, wherein
the first line and the second line are disposed in a transmission system such that the first line and the second line are coupled to each other in accordance with a same topology.

7. The transmission device of claim 1, wherein
the first card is coupled to a packet network serving as the first line through which a packet is transmitted as the first signal; and
the second card is coupled to an optical transport network (OTN) serving as the second line through which an OTN frame is transmitted as the second signal.

8. A method performed by a transmission device including a plurality of first cards each being coupled to a first line through which a first signal is transmitted and a second card coupled to a second line through which a second signal enabling insertion of the first signal is transmitted, the method comprising:
determining whether or not a data amount of the first signal exceeds a predetermined threshold in the first card; and
when the data amount of the first signal exceeds the predetermined threshold, causing the second card to set, based on destination information in the first signal, the second line through which the first signal is to be transferred.

9. A transmission system comprising:
a plurality of transmission devices, each including:
a plurality of first cards each being coupled to a first line through which a first signal is transmitted, and
a second card coupled to a second line through which a second signal enabling insertion of the first signal is transmitted, wherein
each of the plurality of transmission devices is configured to:
determine whether or not a data amount of the first signal exceeds a predetermined threshold in the first card, and
when the data amount of the first signal exceeds the predetermined threshold, insert the destination information in the first signal into the second signal, transmit a setting request related to the second signal to which the destination information of the first signal has been inserted, to an opposed transmission device, and set, upon receiving a response to the setting request from the opposed transmission device, the second line through which the first signal is to be transferred.
